(19) United States
(12) Patent Application Publication
(10) Pub. No.: US 2020/0040153 A1
(43) Pub. Date: Feb. 6, 2020

(54) METHOD TO INCREASE RECYCLED CONTENT INTO POLYURETHANE FOAM

(71) Applicant: Magna Seating Inc

(72) Inventor: Andrew M. Vivian, Fayette, OH (US)

(21) Appl. No.: 16/531,156

(22) Filed: Aug. 5, 2019

Related U.S. Application Data
(60) Provisional application No. 62/714,295, filed on Aug. 3, 2018.

(51) Int. Cl. C08J 9/02; C08G 18/10; C08G 18/76; C08G 18/71; C08G 18/40; C08J 11/10

(52) U.S. Cl. CPC C08J 9/02; C08G 18/10; C08G 18/7671; C08G 2101/00; C08G 18/40; C08J 11/10; C08G 18/71

(57) ABSTRACT

A method of recycling polyurethane foam scrap by recovering polyols from the polyurethane foam scrap using a glycolysis/transesterification process, reacting methylene diphenyl isocyanate (MDI) with virgin polyol and recycled polyol to make a prepolymer with recycled content, and mixing the prepolymer with recycled content with 4,4′-methylenediphenyl diisocyanate, isocyanic acid, polymethylenepolyphenylene ester, and di-phenylnethane-2,4′-diisocyanate to form a MDI prepolymer blend with recycled content, and using the MDI prepolymer blend with recycled content for production of polyurethane foam components having an amount of recycled polyurethane content. Optionally, the MDI prepolymer with recycled content is used during the same foam production process that generated the foam scrap used to recover the recycled polyol.

### CROSS-REFERENCE TO RELATED APPLICATIONS

This application claims priority to U.S. Provisional Application 62/714,295, filed on Aug. 3, 2018, the disclosure of which is incorporated by reference.

### BACKGROUND OF THE INVENTION

### 1. Field of the Invention

The present invention relates to a method of including recycled polyurethane content within new polyurethane foam components. More particularly, the invention relates to recycling polyols from polyurethane foam, reacting methylene diphenyl isocyanate (MDI) with the recycled polyols and virgin polyols to form a prepolymer with recycled content, and mixing 4,4′-methylenediphenyl diisocyanate, isocyanic acid, polymethylenepolyphenylene ester, di-phenylnethane-2,4′-diisocyanate with the prepolymer with recycled content to form a MDI prepolymer blend with recycled content, and using the MDI prepolymer blend with recycled content as part of a polyurethane foam production process to form new polyurethane foam components.

### 2. Description of Related Art

Various methods of recycling polyurethane foam into new polyurethane foam components are known. One known method of recycling polyurethane foam scrap is disclosed in U.S. Pat. No. 8,609,740 wherein polyurethane foam scrap undergoes a glycolysis process to reclaim polyols from the polyurethane. This known method further discloses mixing recycled polyol with virgin polyol to produce a polyol blend with recycled content. In addition, this known method discloses using the polyol blend with recycled content to manufacture new polyurethane foam components, and optionally, for use in the same polyurethane foam production process that produced the polyurethane scrap used to produce the polyol blend with recycled content. However, reactivity of the polyol blend with recycled content is affected by chemical aging since the polyol blend with recycled content degrades overt time via acid/base hydrolysis to ester linkage. Further, the reactivity is further affected by exposure to elevated temperatures during storage. The variation in reactivity of the polyol blend results in variation in gel time during the reaction process when producing new polyurethane foam and can result in increased foam defects and foam scrap.

U. S. Publication 2015/0274922 discloses a second known method of recycling polyurethane foam scrap wherein a prepolymer is mixed with recycled foam pieces and the mixture of prepolymer and foam pieces is used during polyurethane foam production. While this second known method does incorporate polyurethane foam scrap within the new polyurethane foam, the polyols in the scrap foam are unavailable for reacting when generating the new foam. Thus, the foam scrap is not effectively used within the new foam structure.

A third known method is disclosed in U.S. Pat. No. 6,750,260 wherein the polyurethane foam scrap undergoes a glycolysis process to obtain reclaimed polyols. However, this third method is silent about processes to include the reclaimed polyols into new polyurethane foam production.

All of these known methods have limitations. While mixing polyurethane foam pieces in with the prepolymer does blend in recycled polyurethane content into the resultant newly produced foam, the polyols in the recycled foam content are not readily available for inclusion in new foam reactions. Even when the polyurethane foam is processed using glycolysis, the reclaimed polyols and the resultant polyol blend with recycled content may lack chemical stability when stored for a period of time. Further, additional processing steps and/or equipment may be required to include the polyol blend with recycled content into the polyurethane foam production since the source of the recycled polyols, as well as the storage time prior to use, affect the gel time during the polyurethane foam reaction process.

It is desirable, therefore, to include recycled polyurethane content into polyurethane foam production without needing additional processing steps and/or equipment. Further, it is desirable to minimize and/or eliminate the variation in gel time during polyurethane foam production due to variation in reactivity of recycled polyols relating to chemical aging. Finally, it is desirable to incorporate the recycled content into the foam production by including the recycled polyols as part of MDI prepolymer to form MDI prepolymer with recycled content and use the MDI prepolymer with recycled content as part of the foam production.

### SUMMARY OF THE INVENTION

The present invention relates to a method of recycling polyurethane foam scrap by recovering polyols from the polyurethane foam scrap using a glycolysis/transesterification process, reacting methylene diphenyl isocyanate (MDI) with virgin polyol and recycled polyol to make a pre-polymer with recycled content, and mixing the prepolymer with recycled content with 4,4′-methylenediphenyl diisocyanate, isocyanic acid, polymethylenepolyphenylene ester, and di-phenylnethane-2,4′-diisocyanate to form a MDI prepolymer blend with recycled content, and using the MDI prepolymer blend with recycled content for production of polyurethane foam components having an amount of recycled polyurethane content. Optionally, the MDI prepolymer with recycled content is used during the same foam production process that generated the foam scrap used to recover the recycled polyol.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is flow chart of a closed-loop method for incorporating recycled polyurethane content into production of polyurethane foam components according to one embodiment of the present invention;

FIG. 2 is a flow chart of a first known closed-loop process for incorporating recycled polyurethane content into polyurethane foam production;

FIG. 3 is a flow chart of a second known closed-loop process for incorporating recycled polyurethane content into polyurethane foam production;

FIG. 4 is a chart illustrating the effect on polyurethane foam production gel-time using the process shown in FIG. 3 with various concentrations of INFIGREEN® recycled polyol stored at 70° F.;

FIG. 5 is a chart illustrating the effect on polyurethane foam production gel-time using the process shown in FIG. 3 with various concentrations of INFIGREEN® recycled polyol stored at 104° F.;

FIG. 6 is chart illustrating expected variance on polyurethane foam production gel-time using the process shown in FIG. 3 and comparing various concentrations of INFIGREEN® recycled polyol stored for two weeks at 70° F. compared to INFIGREEN® recycled polyol stored for two weeks at 104°;

FIG. 7A is a known chemical formula for reacting methylene diphenyl isocyanate (MDI) and virgin polyol to form prepolymer;

FIG. 7B is chemical formula for reacting MDI, virgin polyol, and recycled polyol to form a prepolymer with recycled content, according to an embodiment of the present invention;

FIG. 8 is a known chemical composition of MDI prepolymer;

FIG. 9 is a chemical composition of MDI prepolymer with recycled content, according to an embodiment of the present invention;

FIG. 10 is a chart illustrating the effect on polyurethane foam production gel-time using the process shown in FIG. 1 with a 8% concentration of MDI prepolymer with recycled content, according to an embodiment of the present invention;

FIG. 11 is a flow chart of a closed-loop process for incorporating recycled polyurethane content into polyurethane foam production, according to an embodiment of the present invention; and

FIG. 12 is a flow chart of a closed-loop process for incorporating recycled polyurethane content into polyurethane foam production, according to another embodiment of the present invention.

### DETAILED DESCRIPTION OF THE EMBODIMENTS

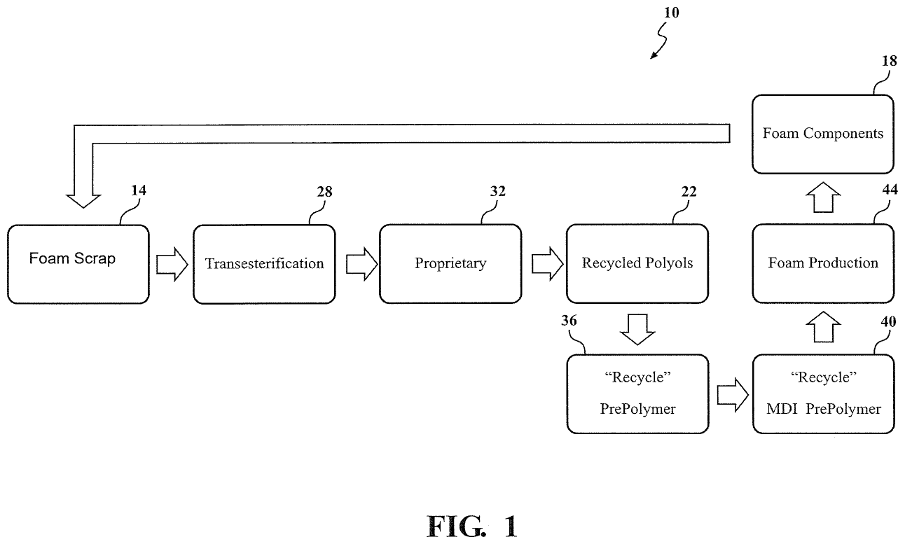

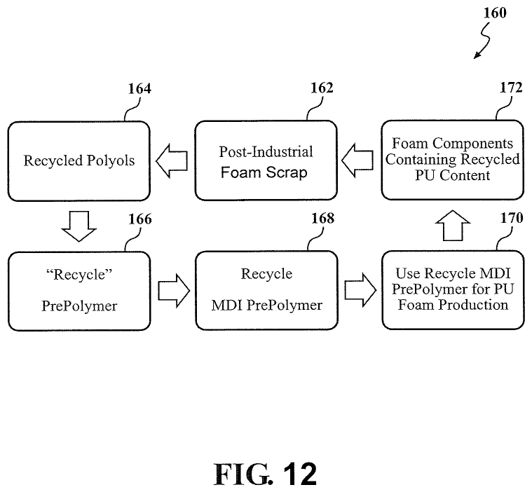

FIGS. 1, 7B, and 9-12 illustrate closed-loop processes for incorporating recycled polyurethane content into polyurethane foam production and related chemical compositions according to embodiments described herein. Directional references employed or shown in the description, figures or claims, such as top, bottom, upper, lower, upward, downward, lengthwise, widthwise, left, right, and the like, are relative terms employed for ease of description and are not intended to limit the scope of the invention in any respect. Referring to the Figures, like numerals indicate like or corresponding parts throughout the several views.

FIG. 1 illustrates a new closed-loop process 10 for recycling polyurethane (PU) foam scrap 14 into new polyurethane foam components 18 according to one embodiment of the present disclosure. As generally known, typical manufacturing processes for production of PU foam components 18 can produce an amount of PU foam scrap 14. It is desirable to recycle the PU foam scrap 14 and include recycled PU content 22 in production of new PU foam components 18. In the new closed-loop process 10 shown in FIG. 1, the scrap PU foam 14 is processed through transesterification 28 and other proprietary steps 32 to produce recycled polyols 22. The recycled polyols 22 are used to make a recycle prepolymer 36 that is used to make a recycle MDI prepolymer 40. The recycle MDI prepolymer 40 is used in the PU foam production 44 to make the PU foam components 18. The process flow is referred to as a “closed-loop” process when the foam scrap 14, from the specific PU foam production 44 and resulting PU foam components 18, is used to make the recycled polyols 22 which are used in the specific PU foam production 44. Additional details of this new closed-loop process 10 will be discussed below in comparison to currently known closed-loop processes.

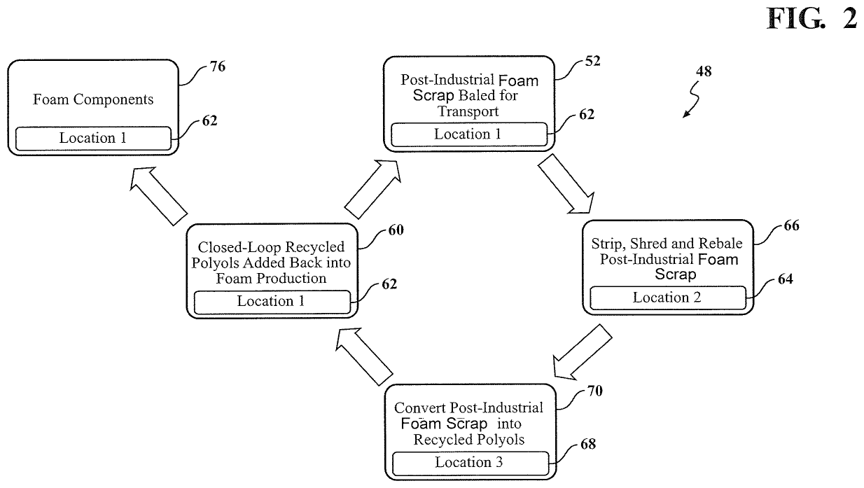

One known method 48 of recycling PU foam scrap 52 into PU foam production 60 is generally shown in FIG. 2 where post-industrial PU foam scrap 52 is baled for transport at a PU foam production facility 62 and shipped to a second location 64 to be stripped, shredded, and rebated 66. Bales of shredded post-industrial PU foam scrap 66 are shipped to a third location 68 for conversion into recycled polyols 70. The recycled polyols 70 are returned to the PU foam production facility 62 and used for production 60 of new PU foam components 76. As shown in FIG. 2, PU foam scrap 52 from the manufacturing process 60 using recycled polyols 70 is baled for transport 52 and the closed-loop method 48 continues as desired. While not shown, this known process 48 can be an open-loop process where the PU foam scrap 52 from a specific manufacturing process 60 at a first manufacturing facility 62 is baled, stripped and shredded at a second facility 64, converted into recycled polyols 70 at a third facility 68, and the recycled polyols 70 sent to a different manufacturing facility or used in a different PU foam production process than the foam production process 60 that originally produced the PU foam scrap 52.

Each process step shown in FIG. 2 may occur at different facilities or the same facility, and may occur at different locations or the same physical location as desired. For example, a single facility may comprise a plurality of locations within the facility for performing the steps of foam production, baling foam scrap, shredding foam scrap, and converting the foam scrap into recycled polyols. Likewise, the process steps may occur at different facilities, each having a respective physical location. Further, each facility may be owned by a single entity or may be separate entities, such as a supplier that specialize reclaiming polyols and a manufacturer of foam components as examples. For the process flows illustrated in FIGS. 1-3 and 11, whether a known process or a process according to an embodiment of the present invention, each process step can occur at the same facility or at different facilities as described with respect to FIG. 2 as desired.

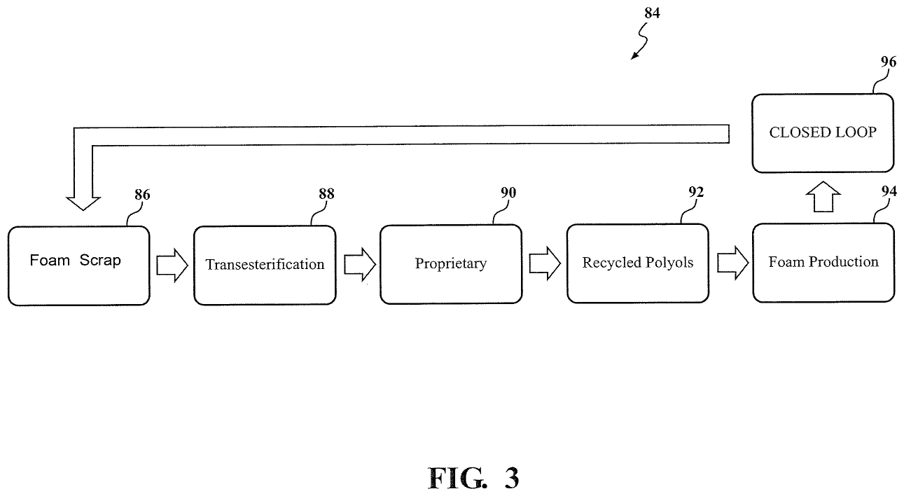

FIG. 3 shows a second known closed-loop process 84 for reusing post-industrial PU foam scrap 86 wherein the PU foam scrap 86 is processed through glycolysis/transesterification 88 as well as additional proprietary processes 90 to produce recycled polyols 92. The recycled polyols 92 are used during PU foam production 94. The process 84 is considered a closed-loop process 96 when PU foam scrap 86 produced from a specific foam production process 94 is used to make recycled polyols 92 for that same foam production process 94. A closed-loop process 96 is desired when incorporating recycled PU foam polyols 92 into PU foam production 94 since the closed-loop process 96 minimizes chemistry variation.

One known recycled polyol 92 is INFIGREEN® produced by Emery Oleochemicals. Emery Oleochemicals' INFIGREEN® technology utilizes glycolysis/transesterification 88 and includes additional proprietary steps 90 to rebuild the recycled polyol 92 for a target application. INFIGREEN® 300 and 420A are examples of available INFIGREEN® formulations. The disclosed embodiment uses INFIGREEN® 200801 which is a formulation of INFIGREEN® adjusted for a desired hydroxyl value and viscosity at 25° C. and produced using post-industrial PU foam scrap 86 from a specific PU foam production process 94 at a specific manufacturing facility (not shown). The INFIGREEN® 200801 is returned to the specific manufacturing facility for incorporation into the specific PU foam production process 94 that originally produced the PU foam scrap 86 used to create INFIGREEN® 200801 (hereinafter “INFIGREEN®”). Selection of a desired hydroxyl value and viscosity for INFIGREEN® is commonly known in the art of PU foam production 94. Further, it is also known in the art to reuse PU foam scrap 86 recycled into INFIGREEN® recycled polyol 92 as part of a closed-loop process 84 for PU foam production 94 since variability and formulation changes are minimized by returning post-industrial PU foam scrap 86 to the same foam production 94 that generated the PU foam scrap 86.

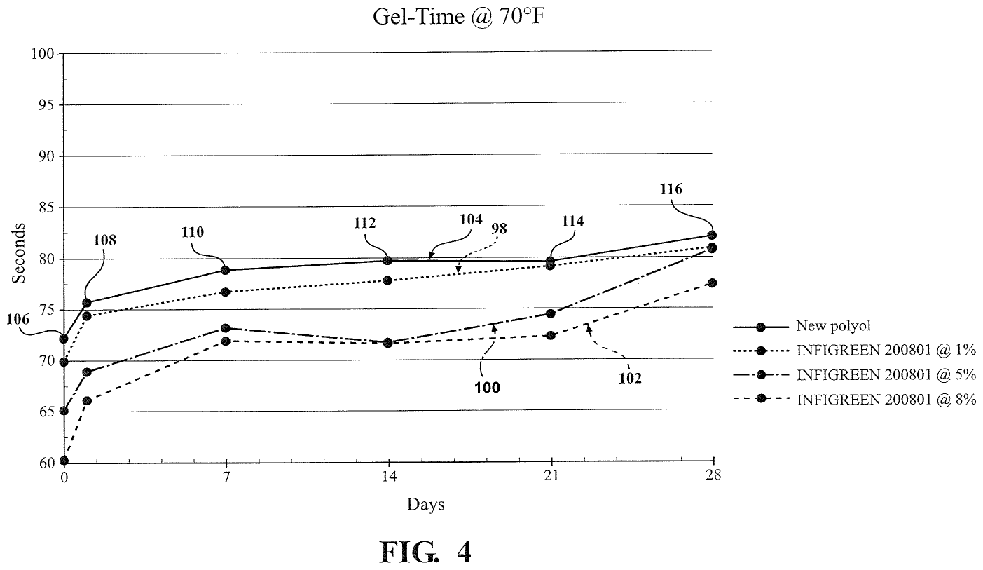

As is generally known in the art of PU foam production 94, PU foam is produced by reacting a di- or tri-polyisocyanate with a polyol to make a urethane polymer. The polymerization reaction time is commonly described as gelation reaction or gel time. The amount of INFIGREEN® recycled polyol 92 included into the formulation for PU foam production 94 affects the gel time as shown in FIG. 4.

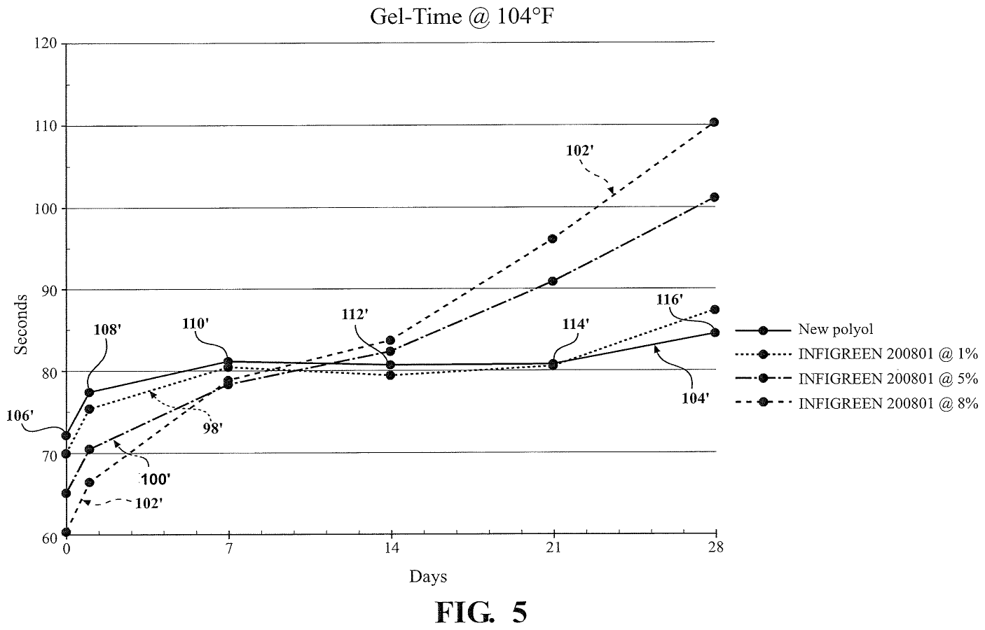

When INFIGREEN® recycled polyol is incorporated directly into the PU foam production process, the gel time is affected by chemical aging of the INFIGREEN® recycled polyol over time. The gel time is also affected by the amount of INFIGREEN® recycled polyol incorporated into the formulation. FIGS. 4 and 5 illustrate the change in gel time for INFIGREEN® recycled polyol in comparison to non-recycled polyol (i.e., virgin or new polyol) when the INFIGREEN® recycled polyol and the new polyol was stored at a specific temperature for a period of time. FIGS. 4 and 5 illustrate the performance of INFIGREEN® 200801; however, other formulations of INFIGREEN®, with different a hydroxyl value, viscosity, and alternate PU foam scrap source, will likely be similarly affected. It will be appreciated that the actual gel time and rate of change in gel time will be dependent on the specific formulation of INFIGREEN® as well as the remaining formulation used for PU foam production.

Referring to FIG. 4, the gel time of INFIGREEN® recycled polyol and new polyol were evaluated as received from the supplier. The INFIGREEN® recycled polyol was added to the PU foam formulation replacing about 1%, about 5%, and about 8% of the new polyol. Both the INFIGREEN® recycled polyol and the new polyol were stored at 70° F. and the gel time evaluated as received and after about 1 day, 7 days, 14 days, 21 days, and 28 days of storage at 70° F. with results shown in FIG. 4. The gel time of the INFIGREEN® at about 1%, about 5%, and about 8% concentration and after storage at 70° F. is represented as curves 98, 100, and 102, respectively. The gel time of new polyol after storage at 70° F. is represented as curve 104. As illustrated for the gel time curve of new polyol 104, the gel time was evaluated as received 106, after about 1 day 108, after about 7 days 110, after about 14 days 112, after about 21 days 114, and after about 28 days 116 of storage at 70° F. While not labeled in FIG. 4, the gel time for the various concentrations 98, 100, 102 of INFIGREEN® are similarly shown for comparison.

As shown in FIG. 4, the gel time using various concentrations of INFIGREEN® recycled polyol 98, 100, 102 was generally less than the gel time of the new polyol 104. However, while both the new polyol 104 and the various concentrations of INFIGREEN® recycled polyol 98, 100, 102 had an increase in gel time over the shown time period, the amount of change in the gel time after 28 days of storage at 70° F. appears related to the concentration of INFIGREEN® 98, 100, 102 used during the foam production. The gel time for new polyol 104 increased about 10 seconds after 28 days of storage at 70° F. In comparison, the gel time for the 8% concentration of INFIGREEN® recycled polyol 102 increased about 17 seconds after 28 days of storage at 70° F.

Both the INFIGREEN® recycled polyol and the new polyol were stored at 104° F. and the gel time evaluated as received and after about 1 day, 7 days, 14 days, 21 days, and 28 days of storage at 104° F. with results shown in FIG. 5. The INFIGREEN® recycled polyol was added to the PU foam formulation replacing about 1%, about 5%, and about 8% of the new polyol. The gel time of the INFIGREEN® at about 1%, about 5%, and about 8% concentration and after storage at 104° F. is represented as curves 98′, 100′, and 102′, respectively. The gel time of new polyol after storage at 104° F. is represented as curve 104′. As illustrated for the gel time curve of new polyol 104′, the gel time was evaluated as received 106′, after about 1 day 108′, after about 7 days 110′, after about 14 days 112′, after about 21 days 114′, and after about 28 days 116′ of storage at 104° F. While not labeled in FIG. 5, the gel time for the various concentrations 98′, 100′, 102′ of INFIGREEN® are similarly shown for comparison.

The gel time of the new polyol 104′ increased about 12 seconds after 28 days storage at 104° F. In comparison, the inclusion of 8% INFIGREEN® recycled polyol 102′ increased the gel time by about 50 seconds after 28 days storage at 104° F. By comparing FIGS. 4 and 5, it will be appreciated that the rate of change in gel time is affected by the concentration of INFIGREEN® recycled polyol 98, 100, 102, by the storage temperature, and the length of storage time. While the gel time of new polyol 104 is affected by the storage time and temperature of storage, the effect on the gel time of new polyol 104 is significantly less than the effect on the gel time of the various concentrations of INFIGREEN® recycled polyol 98, 100, 102.

The INFIGREEN® recycled polyol degrades over time via acid/base hydrolysis to ester linkage. The reactivity of the resin blend (i.e., the blend of new polyol and INFIGREEN® and other additives) is adversely affected over time as shown in FIGS. 4 and 5. Foam production is impacted from the change in reactivity over time and with exposure to elevated storage temperatures. The decrease in reactivity results in physical foam defects, increased foam repairs, and increased scrap rates.

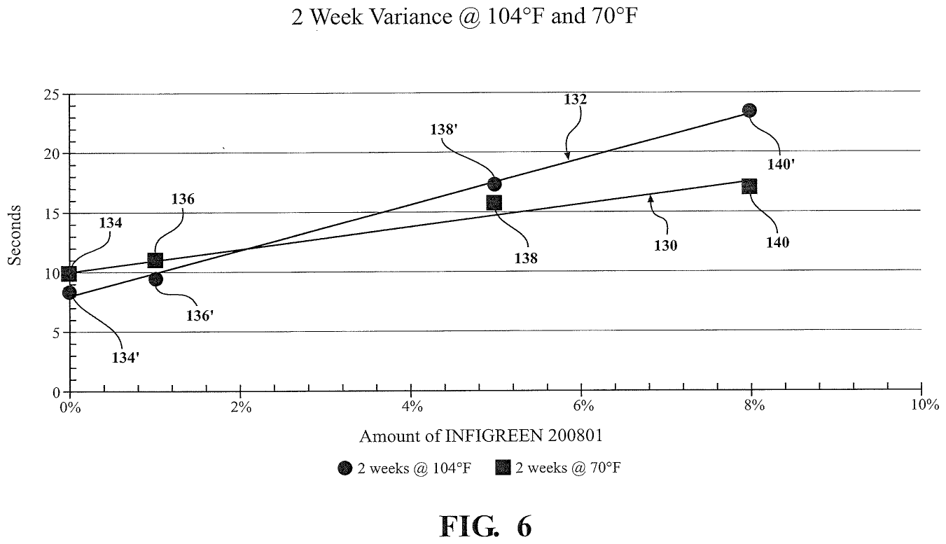

FIG. 6 shows expected variance in gel time after two weeks storage of a mixture of INFIGREEN® recycled polyol and new polyol stored at 70° F. and at 104° F. for about 0%, about 1%, about 5%, and about 8% INFIGREEN® concentrations of polyol with the remaining polyol being new polyol. The gel time of various INFIGREEN® concentrations and after storage at 70° F. and storage at 104° F. for two weeks is represented by trend lines 130 and 132, respectively. The gel time was evaluated for new polyol (i.e. 0% concentration of INFIGREEN®) 134, 134′, 1% concentration of INFIGREEN® 136, 136′, 5% concentration of INFIGREEN® 138, 138′, and 8% concentration of INFIGREEN® 140, 140′, after storage at 70° F. and storage at 104° F., respectively. As illustrated, the amount of variance in the gel time increases as the concentration of INFIGREEN® increases in the mixture. Further, the amount of variance is generally greater for the INFIGREEN® 132 stored for two weeks at 104° F. than for the INFIGREEN® 130 stored at 70° F. when the concentration of INFIGREEN® is above 1% concentration. The expected variance in gel time of a 5% INFIGREEN® blend is between about 14.7 seconds to about 17.4 seconds after about two weeks storage as compared to the new polyol (i.e., 0% concentration of INFIGREEN®).

It is desirable to include recycled content in the PU foam production process. Certain original equipment manufacturers (OEM) prefer about 5% recycled content in the produced PU foam components. The amount of desired recycled content is specified by the OEM. When 5% concentration of INFIGREEN® is used with new polyol during the PU foam production process, there is variation in the gel time due to the storage age and storage temperature of the INFIGREEN®. It is desirable to reduce the variation in gel time as well as reduce the physical foam defects, foam repairs, and scrap rates related to the chemical shelf life of INFIGREEN®.

One method of reducing variation in gel time is to manage chemical inventory levels to ensure fast consumption of polyol resin. However, there is an increased risk of having inadequate polyol resin supply if the stored inventory is insufficient to support the PU foam production requirements.

A second method is to add INFIGREEN® during the PU foam production process by injecting INFIGREEN® into a multi-stream pour head. However, this requires new and costly equipment that may be undesirable in certain applications.

The disclosed method shown in FIG. 1 eliminates the storage of INFIGREEN® at the PU foam production facility by using the recycled polyol (i.e., INFIGREEN®) to form a version of MDI prepolymer with recycled content (i.e., “recycle MDI prepolymer) that is used for the PU foam production.

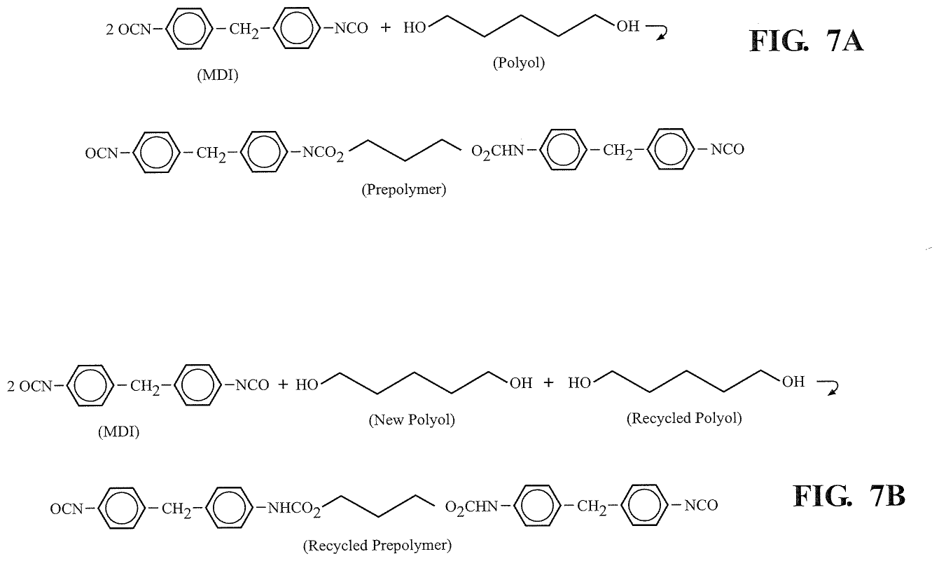

Typically, prepolymer is created through a reaction of methylene diphenyl isocyanate (hereinafter “MDI”) and new polyol to create new prepolymer as shown in FIG. 7A. As shown in FIG. 7B, about 7% to about 12% of the new polyol is replaced with recycled polyol in the form of INFIGREEN® to produce a prepolymer with recycled polyol content. This prepolymer with recycled polyol content is described as “recycle prepolymer”.

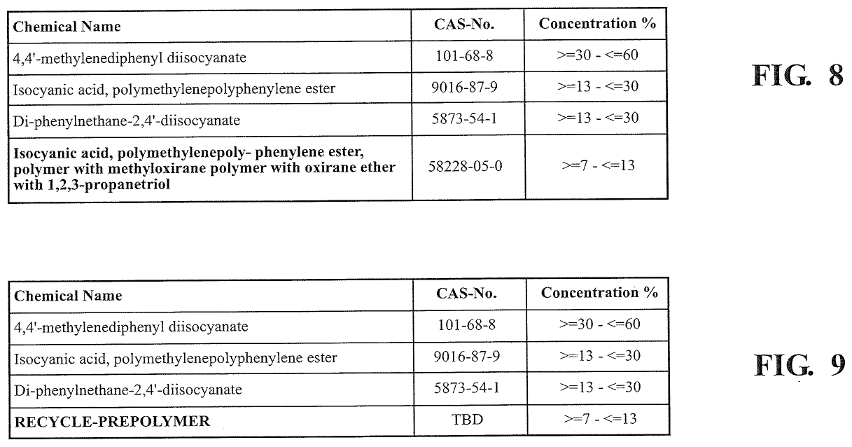

FIG. 8 shows the general chemical formulation of Suprasec® 7447 MDI produced by Huntsman Corporation. Suprasec® 7447 includes about 30% to about 60% concentration of 4,4′-methylenediphenyl diisocyanate (i.e., 4,4′-MDI), about 13% to about 30% isocyanic acid and polymethylenepolyphenylene ester (i.e., polymeric MDI), about 13% to about 30% di-phenylnethane-2,4′-diisocyanate (i.e., 2,4′-MDI), and about 7% to about 13% prepolymer comprising isocyanic acid, polymethylenepoly-phenylene ester, and polymer with methyloxirane polymer with oxirane ether with 1,2,3-propanetriol.

The new recycle MDI prepolymer formulation, according to an embodiment of the present disclosure, is generally shown in FIG. 9. The recycle MDI prepolymer is a modified version of Suprasec® 7447 wherein recycle prepolymer is substituted for the isocyanic acid, polymethylenepoly-phenylene ester, polymer with methyloxirane polymer with oxirane ether with 1,2,3-propanetriol. The new recycle MDI prepolymer formulation includes about 30% to about 60% concentration of 4,4′-MDI, about 13% to about 30% polymeric MDI, about 13% to about 30% of 2,4′-MDI, and about 7% to about 13% recycle prepolymer. This results in a modified version of Suprasec® 7447 including recycled PU content. While Suprasec® 7447 is illustrated in the disclosed embodiment, it will be appreciated that recycle prepolymer can be included in other formulations of MDI prepolymer as desired for a specific application.

The closed-loop PU foam production cycle shown in FIG. 1 uses post-industrial PU foam scrap from a specific manufacturing facility, and optionally a specific PU foam production process, recovers the polyol content using a transesterification process as well as additional proprietary processes, to produce recycled polyols. The recycled polyols are combined with MDI and new polyol to produce recycle prepolymer. The recycle prepolymer is incorporated into the production of the MDI prepolymer to make recycle MDI prepolymer. The recycle MDI prepolymer is sent back to the specific manufacturing facility and used in the PU foam production process to make new PU foam components. The recycle MDI prepolymer is optionally used in a concentration of about 7% to about 12% during the production of the PU foam in order to have about 5% recycled PU content in the new PU foam. It will be appreciated that more or less MDI prepolymer can be used during PU foam production as desired for a specific application. The foam scrap from the PU foam production is sent for recycling and the closed-loop process continues indefinitely as desired.

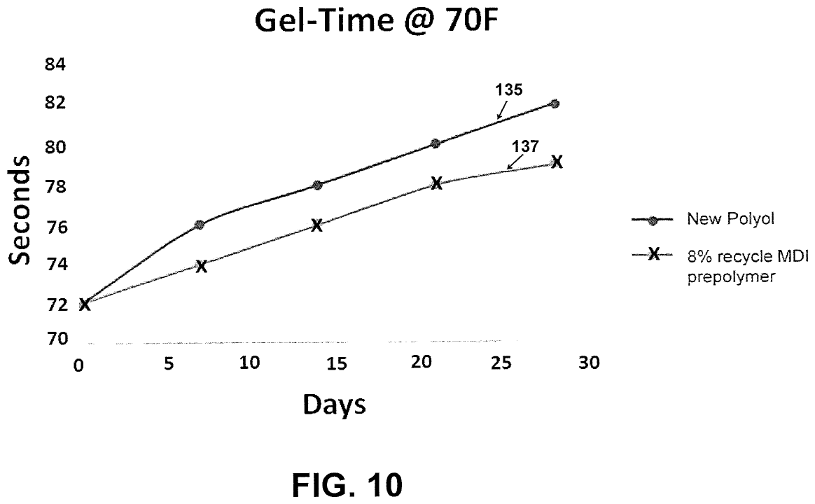

The produced PU foam components have a specific amount of recycled PU content based on the amount of recycled polyol included in the production of the recycle prepolymer, the amount of recycled prepolymer included in the production of the recycle MDI prepolymer, and the amount of recycle MDI prepolymer included in the production of the PU foam components. The recycled polyols are incorporated into the prepolymer prior to adding the prepolymer to make recycle MDI prepolymer. The recycle MDI prepolymer can be used to manufacture PU foam using standard manufacturing processes. The gel time variation due to the storage time and temperature of the INFIGREEN® does not affect the PU foam production process when the recycled polyols are incorporated into the recycle prepolymer and into the resulting recycle MDI prepolymer since the storage and use of INFIGREEN® recycled polyol is eliminated at the PU foam production facility. Referring to FIG. 10, the gel time variations of new polyol 135 and a polyol utilizing a recycle MDI prepolymer 137 are evaluated when stored at 70° F. The gel time variation of new polyol 135 varies about 10 seconds when stored about 28 days. The gel time variation of a polyol utilizing a recycle MDI prepolymer 137 varies about 7 seconds when stored about 28 days.

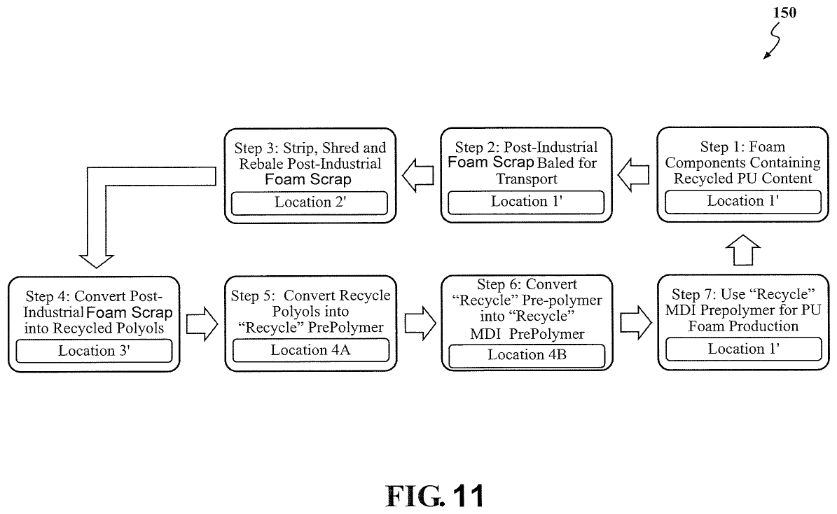

A closed-loop process flow chart 150 for recycling PU foam scrap is shown in FIG. 11 according to an embodiment of the present disclosure. While this flow chart 150 can include additional steps and certain steps can optionally be combined or omitted, this flow chart 150 generally illustrates process steps for recycling polyurethane foam scrap into new polyurethane foam components according to an embodiment of the present disclosure. Further, since a closed-loop process is shown, any one of the shown steps can be considered as the initial step. As illustrated, step 1 includes polyurethane foam components containing recycled PU content at location 1′. During the production of PU foam components, a certain amount of post-industrial PU foam scrap is produced, either as a byproduct of the foam production process or as PU foam components that are defective or are further damaged. In step 2, the post-industrial PU foam scrap is baled for transport at location 1′. The PU foam scrap can be accumulated and prepared to be transported without actually bailing the PU foam scrap. For example, the PU foam scrap can be placed in a container suitable for transport. In step 3, the PU foam scrap is stripped of non-polyurethane foam materials and shredded at location 2′. The shredded PU foam scrap is rebaled (or placed in a container or a package) and transported to step 4. In step 4, the shredded PU foam scrap is converted into recycled polyols at location 3′. In step 5, the recycled polyols are converted into recycle prepolymer at location 4A. In step 6, the recycle prepolymer is converted into recycle MDI prepolymer at location 4B. In step 7, the recycle MDI prepolymer is used during PU foam production at location 1′ such that the resultant PU foam components contain recycled PU content. As described above with the known process chart 48 shown in FIG. 2, each of the steps 1-7 in process chart 150 can be performed at the same or different facilities, at different locations, within a specific facility, or any combinations of facilities and locations within the facilities.

Another closed-loop process flow chart 160 for recycling PU foam scrap 162 is shown in FIG. 11 according to an embodiment of the present disclosure. As shown in FIG. 11, post-industrial PU foam scrap 162 is converted into recycled polyols 164. One disclosed method of recycling polyols 164 from PU foam 162 is using glycolysis/transesterification along with additional proprietary processes to rebuild the recycled content polyol 164. An example of recycled polyols 164 is INFIGREEN® by Emery Oleochemicals, and specifically INFIGREEN® 200801.

As shown in FIG. 11, the recycled polyols 164 are converted into recycle prepolymer 166. As discussed above, recycle prepolymer 166 is formed by reacting MDI, new polyol, and recycled content polyol 164 to form recycle prepolymer 166. The recycle prepolymer 166 is combined with 4,4′-MDI, polymeric MDI, and 2,4′-MDI to form recycle content MDI pre-polymer 168. The recycle MDI prepolymer 168 is added to the PU foam production process 170 using standard production processes to produce PU foam components having recycled PU content 172.

While this closed-loop process 160 can optionally be done in one facility, due to the availability of certain manufacturing processes and equipment, it is also likely this process will include more than one facility. For example, a manufacturing facility that produces PU foam components may prefer not to strip and shred post-industrial foam scrap. It may be cost effective to bale the foam scrap and ship to a dedicated facility for processing post-industrial foam scrap. Likewise, sending the shredded foam scrap to a facility that reclaims recycled polyols from foam scrap using glycolysis/transesterification, as well as additional proprietary steps to rebuild the recycled content polyol may be desirable. For example, the shredded foam scrap may be transported to Emery Oleochemicals for processing to form INFIGREEN® recycle content polyol with the hydroxyl value and viscosity adjusted to desired values. The recycle content polyol can optionally be converted into recycle prepolymer at Emery Oleochemicals or INFIGREEN® can be shipped to another facility for this process step. Huntsman Corp. may receive INFIGREEN® recycled content polyol from Emery Oleochemicals and react INFIGREEN® along with non-recycled (new) polyol and MDI to create recycled content prepolymer, Huntsman Corp. can mix recycle content pre-polymer with 4,4′-MDI, 2,4′-MDI, and polymeric MDI to create recycle content Suprasec® 7447 MDI blend. The recycle content Suprasec® 7447 MDI blend is supplied back to the manufacturing facility that originally generated the PU foam scrap for inclusion in the PU foam production process. It will be appreciated that other MDI blend formulations may be adjusted by including recycled content polyol in the production of recycle content prepolymer.

One benefit of using recycled polyols to form recycle MDI prepolymer is a reduction in gel time variation in the PU foam production process since the recycled polyol (INFIGREEN®) is not stored at the manufacturing facility. A second benefit is a closed loop PU foam recycling process wherein recycled polyol (INFIGREEN®) is not added separately to the PU foam production process since the recycled polyols are incorporated into the recycle MDI prepolymer. A third benefit is a reduction in PU foam defects, foam repairs, and foam scrap since the recycle polyol is included into the recycle MDI prepolymer.

The invention has been described in an illustrative manner, and it is to be understood that the terminology, which has been used, is intended to be in the nature of words of description rather than of limitation. Many modifications and variations of the present invention are possible in light of the above teachings. It is, therefore, to be understood that within the scope of the appended claims, the invention may be practiced other than as specifically described.

What is claimed is:

1. A polyurethane foam containing recycled polyurethane content, said polyurethane foam comprising:
methylene diphenyl isocyanate (MDI) prepolymer with recycled content;
said MDI prepolymer with recycled content formed by combining recycle prepolymer, 4,4′-methylenediphenyl diisocyanate, isocyanic acid, polymethylenepolyphenylene ester, and di-phenylnethane-2,4′-diisocyanate; and
said recycle prepolymer formed by reacting recycled polyols with 4,4′-methylene diphenyl isocyanate.

2. The polyurethane foam as set forth in claim 1, wherein said recycled polyols are recovered from said polyurethane foam using glycolysis and/or transesterification.

3. The polyurethane foam as set forth in claim 2, wherein said polyurethane foam is formed during a first manufacturing process including said MDI prepolymer with recycled content;
said recycled polyols are reclaimed from post-industrial polyurethane foam scrap from said first manufacturing process; and
said MDI prepolymer with recycled content containing said recycled polyols from said post-industrial polyurethane foam scrap from said first manufacturing process.

4. The polyurethane foam as set forth in claim 3, wherein said MDI prepolymer with recycled content forms about 7% to about 12% composition of said polyurethane foam.

5. A method of producing polyurethane foam having recycled polyurethane content, said method comprising:
adding recycle MDI prepolymer to a polyurethane foam production process;
producing post-industrial polyurethane foam scrap from said polyurethane foam production process;
recovering recycled polyols from said post-industrial polyurethane foam scrap;
reacting recycled polyols with methylene diphenyl isocyanate to form recycle prepolymer; and
combining recycle prepolymer with 4,4′-methylenediphenyl diisocyanate, isocyanic acid, polymethylenepolyphenylene ester, and di-phenylnethane-2,4′-diisocyanate to form said recycle MDI prepolymer.

6. The method as set forth in claim 5, said method comprising:
recovering recycled polyols from said post-industrial polyurethane foam scrap using glycolysis and/or transesterification.

7. The method as set forth in claim 6, said method comprising:
shredding said post-industrial polyurethane foam scrap prior to recovering said recycled polyols.

8. The method as set forth in claim 7, said method comprising:
pre-reacting said recycled polyols with virgin polyols and 4,4′ methylene diphenyl isocyanate to form recycle prepolymer.

9. The method as set forth in claim 8, said method comprising:
a closed-loop polyurethane foam production process comprising recycle MDI prepolymer produced from post-industrial polyurethane foam scrap from said polyurethane foam production process.

10. A methylene diphenyl isocyanate (MDI) prepolymer with recycled polyurethane content, said MDI prepolymer comprising:
recycled polyols pre-reacted with 4,4′ methylene diphenyl isocyanate to form recycle prepolymer;
4,4′-methylenediphenyl diisocyanate;
isocyanic acid;
polymethylenepolyphenylene ester; and
di-phenylnethane-2,4′-diisocyanate.

11. The MDI prepolymer with recycled polyurethane content as set forth in claim 10, wherein said 4,4′-methylenediphenyl diisocyanate concentration is between about 30% and about 60%.

12. The MDI prepolymer with recycled polyurethane content as set forth in claim 11, wherein said di-phenylnethane-2,4′-diisocyanate concentration is between about 13% and about 30%.

13. The MDI prepolymer with recycled polyurethane content as set forth in claim 12, wherein said recycle prepolymer concentration is between about 7% and about 13%.

14. The MDI prepolymer with recycled polyurethane content as set forth in claim 13, wherein said recycled polyols are reclaimed from polyurethane foam using transesterification and/or glycolysis.
